(19) United States
(12) Patent Application Publication
(10) Pub. No.: US 2026/0158918 A1
(43) Pub. Date: Jun. 11, 2026

(54) COCKPIT DISPLAY SYSTEM, COCKPIT AND VEHICLE EMPLOYING SYSTEM

(71) Applicant: HON HAI PRECISION INDUSTRY CO., LTD., New Taipei (TW)

(72) Inventor: YI-HENG HUANG, New Taipei (TW)

(21) Appl. No.: 18/989,264

(22) Filed: Dec. 20, 2024

(30) Foreign Application Priority Data
Oct. 23, 2024 (CN) 202411486884.6
Nov. 27, 2024 (CN) 202411717702.1

(51) Int. Cl. B60K 37/00

(52) U.S. Cl. CPC B60K 37/00; B60K 2360/11; B60K 2360/164; B60K 2360/40; B60K 2360/595

(57) ABSTRACT

A cockpit display system for display content according to display signals includes a vehicle infotainment controller and a cockpit display. The vehicle infotainment controller generates first display signals, the first display signals include display signals based on a display port protocol or an embedded display port protocol. The cockpit display is coupled with the vehicle infotainment controller and equipped with a protocol conversion bridge chip, the protocol conversion bridge chip receives the first display signals and converts the first display signals to second display signals, the second display signals include conversion signals based on a low voltage differential signal protocol, and the cockpit display is configured to display content according to the second display signals. A cockpit and a vehicle are also provided.

### TECHNICAL FIELD

The subject matter herein generally relates to vehicle technologies.

### BACKGROUND

The evolution of intelligent cockpit technology has driven a shift towards digitalization and intelligence within vehicle interiors. Cockpit display screens now encompass functionalities such as multi-screen linkage, voice recognition, touch feedback, and vehicle control. However, this advancement presents significant challenges in optimizing hardware design, managing costs, and integrating a multitude of functions.

Currently, Serializer/Deserializer (SerDes) chips are employed to facilitate a transmission of audiovisual signals within a display process of a vehicle cockpit display screen. However, these SerDes chips are characterized by high costs and complex design requirements. Consequently, there exists a potential for improvement in an architecture of a cockpit display system.

### BRIEF DESCRIPTION OF THE DRAWINGS

Implementations of the present disclosure will now be described, by way of embodiments, with reference to the attached figures.

FIG. 1 is a block diagram illustrating a cockpit display system according to an embodiment of the present disclosure.

FIG. 2 is a block diagram illustrating a cockpit according to an embodiment of the present disclosure.

FIG. 3 is a structure diagram illustrating a vehicle according to an embodiment of the present disclosure.

FIG. 4 a block diagram illustrating a cockpit display system according to another embodiment of the present disclosure.

FIG. 5 is a signal interaction diagram illustrating communications between a protocol conversion bridge chip, a control chip, and a display driver chip according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasable connected. The term “comprising,” when utilized, means “including, but not necessarily limited to”; it specifically indicates open-ended inclusion or membership in the so-described combination, group, series, and the like.

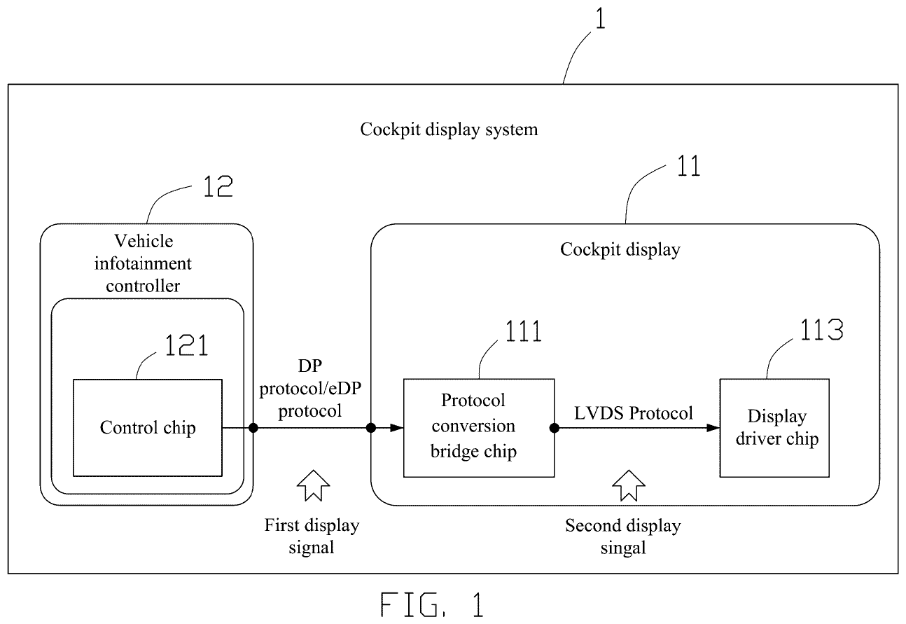

FIG. 1 illustrates an exemplary embodiment of a cockpit display system 1.

The cockpit display system 1 may include a cockpit display 11 and a vehicle infotainment controller 12. The cockpit display 11 is coupled with the vehicle infotainment controller 12.

In one embodiment, the cockpit display 11 may include a display screen. For example, the cockpit display 11 can be a central control display screen, an instrument display screen, a co-pilot display screen, a seat-back display screen, etc. The cockpit display system 1 may include one or more cockpit displays 11. The one or more cockpit displays 11 can be connected with the vehicle infotainment controller 12 via one or more wiring harnesses.

In one embodiment, the vehicle infotainment controller 12 can be an automotive-specific central processor, the vehicle infotainment controller 12 can work as an integrated information processing system of a vehicle based on a vehicle bus system and internet service. For example, the vehicle infotainment controller 12 can transmit audiovisual signals that need to be displayed to the cockpit display 11, and the cockpit display 11 can display corresponding content according to the audiovisual signals, improving driving experiences of vehicle occupants.

In one embodiment, the vehicle infotainment controller 12 is configured to generate first display signals, the first display signals may include display signals based on a display port (DP) protocol or an embedded display port (eDP) protocol. For example, the first display signals include DP protocol signals and/or eDP protocol signals.

The cockpit display 11 is equipped with a protocol conversion bridge chip 111. The protocol conversion bridge chip 111 is configured to receive the first display signals and convert the first display signals to second display signals. The second display signals may include conversion signals based on a low voltage differential signal (LVDS) protocol. For example, the second display signals include LVDS protocol signals.

The cockpit display 11 is configured to display content according to the second display signals.

Comparing with prior art, the protocol conversion bridge chip is equipped in the cockpit display, the protocol conversion bridge chip converts the first display signals outputted by the control chip into the second display signals, and the display driver chip drive the display screen to display according to the second display signals. Thus, the cockpit display system of the embodiment can achieve protocol conversion of the first display signals even without using a codec of a SerDes chip for performing a serialization and deserialization processing on the audiovisual signals. The processed audiovisual signals are transmitted to the cockpit display to display. The cockpit display system reduces a design complexity of display system, and avoids problems of design complexity and chip supply stability risks caused by using SerDes chips.

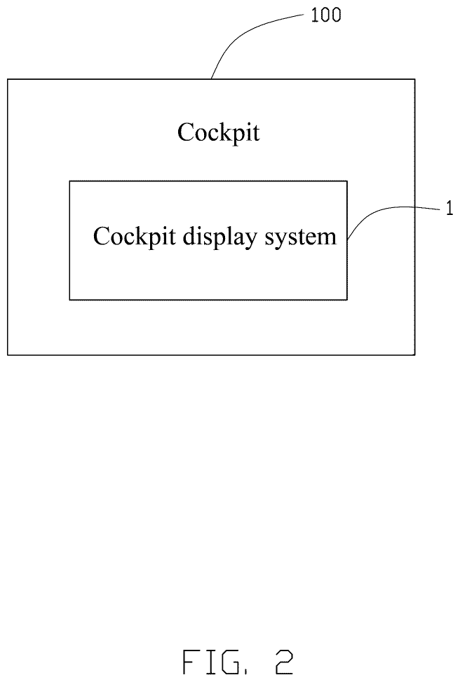

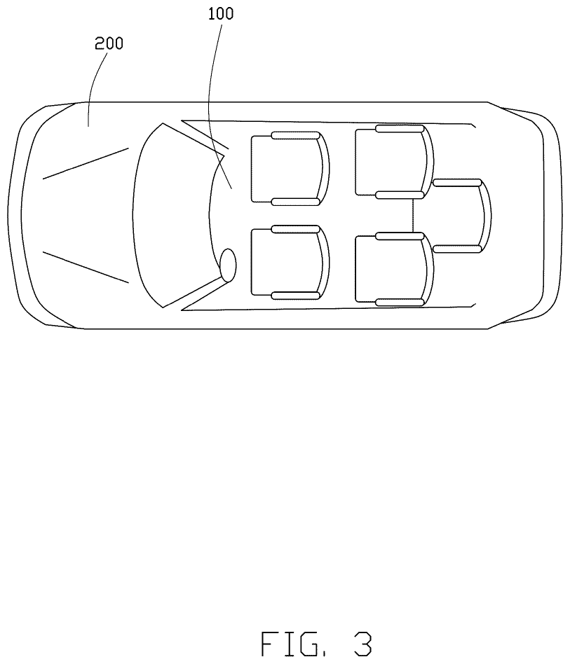

Referring to FIG. 2 and FIG. 3, the cockpit display system 1 can be deployed in a cockpit 100. The cockpit 100 can be a cockpit of a vehicle 200. The vehicle 200 can be a fuel vehicle, a new energy vehicle (for example, electric energy, hydrogen energy), etc.

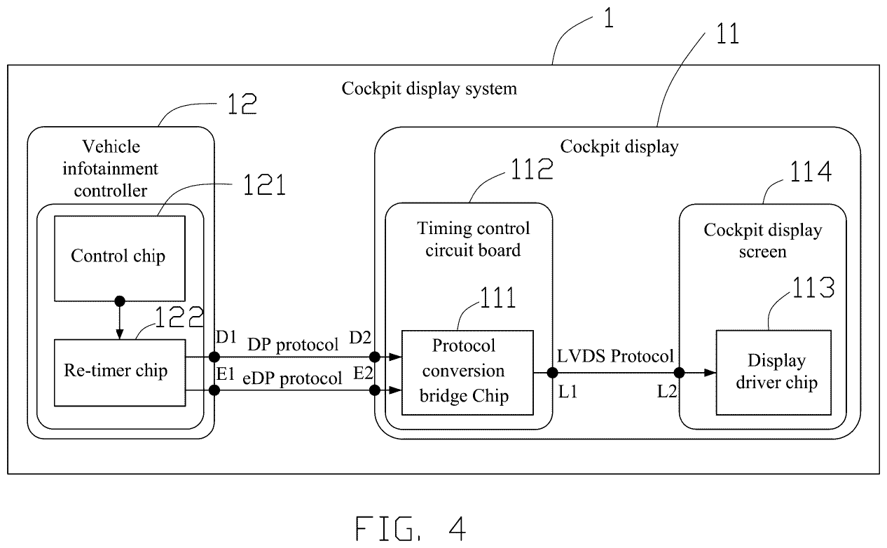

Referring to FIG. 1 and FIG. 4, the vehicle infotainment controller 12 may include a control chip 121. The cockpit display 11 may include a timing control circuit board 112 and a display driver chip 113, the protocol conversion bridge chip 111 is arranged on the timing control circuit board 112. The control chip 121 is coupled with the protocol conversion bridge chip 111, and the protocol conversion bridge chip 111 is further coupled with the display driver chip 113.

The control chip 121 may include a first DP interface D1, the protocol conversion bridge chip 111 may include a second DP interface D2 and a first LVDS interface L1. The control chip 121 can transmit the DP protocol signals to the protocol conversion bridge chip 111 through the first DP interface D1 and the second DP interface D2. The display driver chip 113 may include a second LVDS interface L2, and the protocol conversion bridge chip 111 can convert the DP protocol signals into the LVDS protocol signals (the second display signals) and transmits the LVDS protocol signals to the display driver chip 113 through the first LVDS interface L1 and the second LVDS interface L2.

In one embodiment, the control chip 121 can be a system on chip (SoC), or other chips with data processing or control functions, for example, a microcontroller unit (MCU) chip. The control chip 121 may include one or more first DP interfaces D1. When the cockpit display system 1 includes multiple cockpit displays 11 and the vehicle infotainment controller 12 transmits different information to the multiple cockpit displays 11 for display, the control chip 121 can be equipped with multiple first DP interfaces D1. Each first DP interface D1 is connected to a different cockpit display 11, one first DP interface D1 corresponds to one cockpit display 11.

When the cockpit display system 1 needs to transmit the audiovisual signals to the cockpit display 11 for display, under an electronic image standard protocol (such as a DP protocol), the audiovisual signals are processed by the control chip 121 into the DP protocol signals, and the DP protocol signals are transmitted to the protocol conversion bridge chip 111 through the wire harnesses. The protocol conversion bridge chip 111 converts the DP protocol signals into the LVDS protocol signals, and the LVDS protocol signals are transmitted to the display driver chip 113 through the first LVDS interface L1 and the second LVDS interface L2. The LVDS protocol signals are processed by the display driver chip 113 for display.

In one embodiment, the control chip 121 may include a first eDP interface E1, the protocol conversion bridge chip 111 may include a second eDP interface E2. The control chip 121 transmits the eDP protocol signals to the protocol conversion bridge chip 111 through the first eDP interface E1 and the second eDP interface E2. The protocol conversion bridge chip 111 can convert the eDP protocol signals into the LVDS protocol signals and transmits the LVDS protocol signals to the display driver chip 113 through the first LVDS interface L1 and the second LVDS interface L2. The LVDS protocol signals are processed by the display driver chip 113 for display.

When an electronic image standard protocol used by the cockpit display system 1 for transmitting signals is an eDP protocol, the control chip 121 is required to include the first eDP interface E1, and the protocol conversion bridge chip 111 is required to include the second eDP interface E2. The control chip 121 can process the audiovisual signals into the eDP protocol signals. The eDP protocol signals are transmitted to the protocol conversion bridge chip 111 through the wire harnesses. The protocol conversion bridge chip 111 converts the eDP protocol signals into the LVDS protocol signals and transmits the LVDS protocol signals to the display driver chip 113 through the first LVDS interface L1 and the second LVDS interface L2. The LVDS protocol signals are processed by the display driver chip 113 for display.

In one embodiment, the control chip 121 may include the first DP interface D1 and the first eDP interface E1, or only include the first DP interface D1, or only include the first eDP interface E1. Similarly, the control chip 121 may include one or more first eDP interfaces E1.

In one embodiment, the vehicle infotainment controller 12 may further include a re-timer chip 122. The re-timer chip 122 is coupled with the control chip 121 and the protocol conversion bridge chip 111. The re-timer chip 122 can perform a balance optimization processing on the first display signals outputted by the control chip 121, and transmits processed first display signals to the protocol conversion bridge chip 111.

When a long-distance transmission and a signal quality requirement of high resolution are required in a vehicle display, the re-timer chip 122 can be equipped in the vehicle infotainment controller 12. On the one hand, the re-timer chip 122 can balance transmitted signal. On the other hand, signals with deterministic jitter and/or random jitter can be optimized by the re-timer chip 122, clean and complete signals can be outputted to the protocol conversion bridge chip 111, improving display stability and display integrity of the cockpit display system 1.

In one embodiment, the re-timer chip 122 can be equipped or not equipped in the vehicle infotainment controller 12 according to an actual application. For example, in a case of no need for long-distance transmission or a signal quality requirement of low resolution, the re-timer chip 122 can be not equipped in the vehicle infotainment controller 12.

In one embodiment, when the control chip 121 outputs the eDP protocol signals, the re-timer chip 122 can perform a balance optimization processing on the eDP protocol signals, and transmit processed eDP protocol signals to the protocol conversion bridge chip 111.

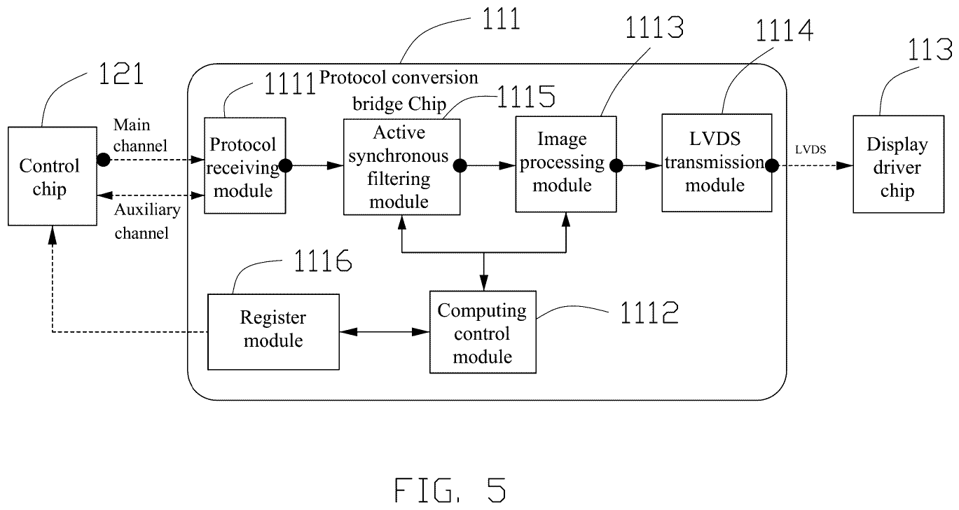

In one embodiment, referring to FIG. 5, a main channel is formed between the control chip 121 and the protocol conversion bridge chip 111. The control chip 121 can transmit audiovisual information of the DP protocol signals and/or the eDP protocol signals to the protocol conversion bridge chip 111 through the main channel.

In one embodiment, the audiovisual information may be videos, audios, etc.

In one embodiment, an auxiliary channel is further formed between the control chip 121 and the protocol conversion bridge chip 111. The control chip 121 can transmit control information and transmission set parameters of the DP protocol signals and/or the eDP protocol signals to the protocol conversion bridge chip 111 through the auxiliary channel, or the protocol conversion bridge chip 111 can transmit the control information and the transmission set parameters of the DP protocol signals and/or the eDP protocol signals back to the control chip 121 through the auxiliary channel.

For example, before transmitting the audiovisual information, in order to meet a stable signal requirement of cockpit display, caches of the vehicle infotainment controller 12 and the protocol conversion bridge chip 111 can be read and written through the auxiliary channel, to adjust and test bidirectional differential pressure compensation, frequency, and channel usage.

By setting the main channel and the auxiliary channel between the control chip 121 and the protocol conversion bridge chip 111, the audiovisual signals can be transmitted for display, and the control information can be transmitted to control a display content of the cockpit display.

In one embodiments, when the re-timer chip 122 is provided in the cockpit display system 1, the main channel and the auxiliary channel can be configured between the re-timer chip 122 and the protocol conversion bridge chip 111.

In one embodiments, the cockpit display 11 includes a cockpit display screen 114, and the display driver chip 113 is arranged in the cockpit display screen 114. The cockpit display screen 114 can be a display screen inside the cockpit 100.

Referring to FIG. 5, the protocol conversion bridge chip 111 may include a protocol receiving module 1111, a computing control module 1112, an image processing module 1113, and an LVDS transmission module 1114. The image processing module 1113 communicates with the protocol receiving module 1111, the LVDS transmission module 1114, and the computing control module 1112. The protocol receiving module 1111 can transmit the DP protocol signals received from the control chip 121 to the image processing module 1113. The image processing module 1113 can convert the DP protocol signals into the LVDS protocol signals and transmits the LVDS protocol signals to the LVDS transmission module 1114. The LVDS transmission module 1114 can transmit the LVDS protocol signals to the cockpit display screen 114 for display through the display driver chip 113. For example, the display driver chip 113 can drive the cockpit display screen 114 to display based on the LVDS protocol signals.

The DP protocol signals outputted by the control chip 121 can be received and converted to the LVDS protocol signals through the protocol receiving module 1111, the computing control module 1112, the image processing module 1113, and the LVDS transmission module 1114, the LVDS protocol signals can be transmitted to the cockpit display screen 114 for display through the display driver chip 113.

In one embodiment, the protocol receiving module 1111 can transmit the eDP protocol signals received from the control chip 121 to the image processing module 1113. The image processing module 1113 can convert the eDP protocol signals into the LVDS protocol signals and transmits the LVDS protocol signals to the LVDS transmission module 1114. The LVDS transmission module 1114 can transmit the LVDS protocol signals to the cockpit display screen 114 through the display driver chip 113.

In one embodiment, the protocol conversion bridge chip 111 may further include an active synchronization filter module 1115. The active synchronization filter module 1115 can communicate with the protocol receiving module 1111, the image processing module 1113, and the computing control module 1112. The protocol receiving module 1111 can transmit the DP protocol signals received from the control chip 121 to the active synchronization filter module 1115. The active synchronization filter module 1115 may filter and correct the DP protocol signals, and transmit corrected DP protocol signals to the image processing module 1113.

In one embodiment, the active synchronization filter module 1115 can be used in an application environment where an input signal source may be interfered or an intensity of synchronization signals is unstable (for example, long-distance transmission). The active synchronization filter module 1115 can filter high-frequency noises, distortion signals, or jitter signals in input signals. The active synchronization filter module 1115 can further adjust and correct a phase and a pulse width of the input signals, to avoid false synchronization signals interfering with output requirements of display signals.

In one embodiment, the protocol receiving module 1111 can transmit the eDP protocol signals received from the control chip 121 to the active synchronization filter module 1115. The active synchronization filter module 1115 may filter and correct the eDP protocol signals, and transmit corrected eDP protocol signals to the image processing module 1113.

In one embodiment, the protocol conversion bridge chip 111 may further include a register module 1116 communicated with the computing control module 1112. The computing control module 1112 can detect the first display signals (DP protocol signals or eDP protocol signals) outputted by the active synchronous filtering module 1115 and the second display signals (LVDS protocol signals) outputted by the image processing module 1113. The computing control module 1112 can perform a diagnostic analysis on the first display signals and the second display signals, and output diagnostic results to the register module 1116 for storing. The register module 1116 can transmit the diagnostic results to the control chip 121. For example, when the register module 1116 receives the diagnostic results, the register module 1116 can be triggered to output the diagnostic results to the control chip 121.

In one embodiment, the register module 1116 can be equipped according to requirements of vehicle functional safety. For example, under some vehicle safety standards (for example, ISO26262 standard), the vehicle need to have diagnostic mechanisms and error return mechanisms to meet the requirements of vehicle functional safety during driving. Key parameters of information in the register module 1116 are notified through the computing control module 1112 (For example, detect synchronization signals, a backlight of the a display screen is abnormal, screen content cannot be displayed). When an exception is detected by the computing control module 1112, a failure mode can be generated. The computing control module 1112 can return the diagnostic results to the control chip 121 through the register module 1116 with preset security standards. When the control chip 121 receives the diagnostic results including exception, the control chip 121 can control corresponding devices to remind vehicle occupants, thus, the driver can stop the vehicle to check, or drive the vehicle to a service point for maintenance.

Comparing with prior art, on the one hand, the cockpit display system does not need to use the codec in the SerDes chip to serialize and deserialize the audiovisual signals, and the cockpit display system can also achieve sending processed audiovisual signals to the display driver chip for display. The cockpit display system reduces a design complexity of display system, and avoids problems of chip supply stability risks and high time cost caused by using SerDes chips.

On the other hand, the re-timer chip can be set between the control chip and the protocol conversion bridge chip, the re-timer chip can perform a balance optimization processing on the DP/eDP protocol signals, and transmit optimized DP/eDP protocol signals to the protocol conversion bridge chip. Thus, fidelity and integrity of the signals are improved.

Additionally, the active synchronization filter module is equipped in the protocol conversion bridge chip to filter and correct the DP/eDP protocol signals, so as to filter high-frequency noises, distortion signals or jitter signals during signal transmission, and avoid false synchronization signal interfering with the output requirement of the display signals of the cockpit display.

Additionally, the register module is equipped in the protocol conversion bridge chip to perform safety diagnosis during driving, and abnormal diagnosis results can be transmitted to the control chip, the control chip can remind vehicle occupants to stop driving, or drive the vehicle to a service point for maintenance. Thus, driving experiences of the vehicle occupants can be improved.

In one embodiment, when the cockpit display system is deployed in an electronic device of the vehicle 200. The electronic device may include at least one processor, at least one data storage, and a computer program that is stored in the data storage and can be run on the processor. When the processor executes the computer program, one or more vehicle control functions of the vehicle 200 can be achieved.

In one embodiment, the processor can be a central processing unit (CPU), a microprocessor, a digital signal processors (DSP), an application specific integrated circuit (ASIC), a field-programmable gate array (FPGA), or other data processor chip that achieves required functions.

The data storage can be used to store computer programs and/or modules/units, and the processor can realize various functions of the electronic device by running or executing computer programs and/or modules/units stored in the data storage and calling up data stored in the data storage. The data storage can be set in the electronic device, or can be a separate external memory card, such as an SM card (Smart Media Card), an SD card (Secure Digital Card), or the like. The data storage may include various types of non-transitory computer-readable storage mediums. For example, the data storage can be an internal storage system, such as a flash memory, a random access memory (RAM) for the temporary storage of information, and/or a read-only memory (ROM) for permanent storage of information. The data storage can also be an external storage system, such as a hard disk, a storage card, or a data storage medium.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A cockpit display system comprising:
a vehicle infotainment controller, configured to generate first display signals, wherein the first display signals comprise display signals based on a display port (DP) protocol or an embedded display port (eDP) protocol; and
a cockpit display, coupled with the vehicle infotainment controller and equipped with a protocol conversion bridge chip, wherein the protocol conversion bridge chip is configured to receive the first display signals and convert the first display signals to second display signals, the second display signals comprise conversion signals based on a low voltage differential signal (LVDS) protocol, and the cockpit display is configured to display content according to the second display signals.

2. The cockpit display system of claim 1, wherein the first display signals comprise DP protocol signals and/or eDP protocol signals; the vehicle infotainment controller comprises a control chip, the cockpit display comprises a timing control circuit board and a display driver chip, the protocol conversion bridge chip is arranged on the timing control circuit board, the control chip is coupled with the protocol conversion bridge chip, and the protocol conversion bridge chip is further coupled with the display driver chip; and
the control chip comprises a first DP interface, the protocol conversion bridge chip comprises a second DP interface and a first LVDS interface, and the control chip transmits the DP protocol signals to the protocol conversion bridge chip through the first DP interface and the second DP interface; the display driver chip comprises a second LVDS interface, and the protocol conversion bridge chip converts the DP protocol signals into the second display signals and transmits the second display signals to the display driver chip through the first LVDS interface and the second LVDS interface.

3. The cockpit display system of claim 2, wherein the control chip further comprises a first eDP interface, the protocol conversion bridge chip further comprises a second eDP interface, the control chip transmits the eDP protocol signals to the protocol conversion bridge chip through the first eDP interface and the second eDP interface; the protocol conversion bridge chip converts the eDP protocol signals into the second display signals and transmits the second display signals to the display driver chip through the first LVDS interface and the second LVDS interface.

4. The cockpit display system of claim 3, wherein the vehicle infotainment controller further comprises a re-timer chip; the re-timer chip is coupled with the control chip and the protocol conversion bridge chip, the re-timer chip performs a balance optimization processing on the first display signals outputted by the control chip, and transmits processed first display signals to the protocol conversion bridge chip.

5. The cockpit display system of claim 3, wherein a main channel is formed between the control chip and the protocol conversion bridge chip, and the control chip transmits audiovisual information of the first display signals to the protocol conversion bridge chip through the main channel.

6. The cockpit display system of claim 5, wherein an auxiliary channel is further formed between the control chip and the protocol conversion bridge chip, the control chip transmits control information and transmission set parameters of the first display signals to the protocol conversion bridge chip through the auxiliary channel, or the protocol conversion bridge chip transmits the control information and the transmission set parameters of the first display signals back to the control chip through the auxiliary channel.

7. The cockpit display system of claim 2, wherein the second display signals comprise LVDS protocol signals; the cockpit display comprises a cockpit display screen, and the display driver chip is arranged in the cockpit display screen; the protocol conversion bridge chip comprises a protocol receiving module, a computing control module, an image processing module, and an LVDS transmission module; the image processing module communicates with the protocol receiving module, the LVDS transmission module, and the computing control module; the protocol receiving module transmits the first display signals received from the control chip to the image processing module, the image processing module converts the first display signals into the LVDS protocol signals and transmits the LVDS protocol signals to the LVDS transmission module, and the LVDS transmission module transmits the LVDS protocol signals to the cockpit display screen through the display driver chip.

8. The cockpit display system of claim 7, wherein the protocol conversion bridge chip further comprises an active synchronization filter module, the active synchronization filter module communicates with the protocol receiving module, the image processing module, and the computing control module; the protocol receiving module transmits the first display signals received from the control chip to the active synchronization filter module, the active synchronization filter module filters and corrects the first display signals and transmits corrected first display signals to the image processing module.

9. The cockpit display system of claim 8, wherein the protocol conversion bridge chip further comprises a register module communicated with the computing control module, the computing control module detects the first display signals outputted by the active synchronous filtering module and the second display signals outputted by the image processing module, and performs a diagnostic analysis on the first display signals and the second display signals, the computing control module further outputs diagnostic results to the register module for storing, and the register module transmits the diagnostic results to the control chip.

10. A cockpit comprising a cockpit display system, the cockpit display system comprising:
a vehicle infotainment controller, configured to generate first display signals, wherein the first display signals comprise display signals based on a display port (DP) protocol or an embedded display port (eDP) protocol; and
a cockpit display, coupled with the vehicle infotainment controller and equipped with a protocol conversion bridge chip, wherein the protocol conversion bridge chip is configured to receive the first display signals and convert the first display signals to second display signals, the second display signals comprise conversion signals based on a low voltage differential signal (LVDS) protocol, and the cockpit display is configured to display content according to the second display signals.

11. The cockpit of claim 10, wherein the first display signals comprise DP protocol signals and/or eDP protocol signals; the vehicle infotainment controller comprises a control chip, the cockpit display comprises a timing control circuit board and a display driver chip, the protocol conversion bridge chip is arranged on the timing control circuit board, the control chip is coupled with the protocol conversion bridge chip, and the protocol conversion bridge chip is further coupled with the display driver chip; and
the control chip comprises a first DP interface, the protocol conversion bridge chip comprises a second DP interface and a first LVDS interface, and the control chip transmits the DP protocol signals to the protocol conversion bridge chip through the first DP interface and the second DP interface; the display driver chip comprises a second LVDS interface, and the protocol conversion bridge chip converts the DP protocol signals into the second display signals and transmits the second display signals to the display driver chip through the first LVDS interface and the second LVDS interface.

12. The cockpit of claim 11, wherein the control chip further comprises a first eDP interface, the protocol conversion bridge chip further comprises a second eDP interface, the control chip transmits the eDP protocol signals to the protocol conversion bridge chip through the first eDP interface and the second eDP interface; the protocol conversion bridge chip converts the eDP protocol signals into the second display signals and transmits the second display signals to the display driver chip through the first LVDS interface and the second LVDS interface.

13. The cockpit of claim 12, wherein the vehicle infotainment controller further comprises a re-timer chip; the re-timer chip is coupled with the control chip and the protocol conversion bridge chip, the re-timer chip performs a balance optimization processing on the first display signals outputted by the control chip, and transmits processed first display signals to the protocol conversion bridge chip.

14. The cockpit of claim 12, wherein a main channel is formed between the control chip and the protocol conversion bridge chip, and the control chip transmits audiovisual information of the first display signals to the protocol conversion bridge chip through the main channel.

15. The cockpit of claim 14, wherein an auxiliary channel is further formed between the control chip and the protocol conversion bridge chip, the control chip transmits control information and transmission set parameters of the first display signals to the protocol conversion bridge chip through the auxiliary channel, or the protocol conversion bridge chip transmits the control information and the transmission set parameters of the first display signals back to the control chip through the auxiliary channel.

16. The cockpit of claim 11, wherein the second display signals comprise LVDS protocol signals; the cockpit display comprises a cockpit display screen, and the display driver chip is arranged in the cockpit display screen; the protocol conversion bridge chip comprises a protocol receiving module, a computing control module, an image processing module, and an LVDS transmission module; the image processing module communicates with the protocol receiving module, the LVDS transmission module, and the computing control module; the protocol receiving module transmits the first display signals received from the control chip to the image processing module, the image processing module converts the first display signals into the LVDS protocol signals and transmits the LVDS protocol signals to the LVDS transmission module, and the LVDS transmission module transmits the LVDS protocol signals to the cockpit display screen through the display driver chip.

17. The cockpit of claim 16, wherein the protocol conversion bridge chip further comprises an active synchronization filter module, the active synchronization filter module communicates with the protocol receiving module, the image processing module, and the computing control module; the protocol receiving module transmits the first display signals received from the control chip to the active synchronization filter module, the active synchronization filter module filters and corrects the first display signals and transmits corrected first display signals to the image processing module.

18. The cockpit of claim 17, wherein the protocol conversion bridge chip further comprises a register module communicated with the computing control module, the computing control module detects the first display signals outputted by the active synchronous filtering module and the second display signals outputted by the image processing module, and performs a diagnostic analysis on the first display signals and the second display signals, the computing control module further outputs diagnostic results to the register module for storing, and the register module transmits the diagnostic results to the control chip.

19. A vehicle comprising a cockpit, the cockpit comprising a cockpit display system, the cockpit display system comprising:
a vehicle infotainment controller, configured to generate first display signals, wherein the first display signals comprise display signals based on a display port (DP) protocol or an embedded display port (eDP) protocol; and
a cockpit display, coupled with the vehicle infotainment controller and equipped with a protocol conversion bridge chip, wherein the protocol conversion bridge chip is configured to receive the first display signals and convert the first display signals to second display signals, the second display signals comprise conversion signals based on a low voltage differential signal (LVDS) protocol, and the cockpit display is configured to display content according to the second display signals.
